(19) United States
(12) Patent Application Publication
(10) Pub. No.: US 2004/0024278 A1
(43) Pub. Date: Feb. 5, 2004

(54) Single station hazardous material detection and neutralization system for letters and packages

(75) Inventor: Clifford A. Megerle, Thousand Oaks, CA (US)

Correspondence Address: PERKINS, SMITH & COHEN LLP, ONE BEACON STREET, 30TH FLOOR, BOSTON, MA, 02108, US

(73) Assignee: Lockheed Martin Corp., a Maryland corporation

(21) Appl. No.: 10/289,810

(22) Filed: Nov. 7, 2002

Related U.S. Application Data
(63) Continuation-in-part of application No. 10/201,169, filed on Jul. 22, 2002.
(63) Continuation-in-part of application No. 10/277,069, filed on Oct. 21, 2002.
(60) Provisional application No. 60/344,848, filed on Dec. 31, 2001.
(60) Provisional application No. 60/344,848, filed on Dec. 31, 2001.
(60) Provisional application No. 60/330,673, filed on Oct. 26, 2001.

(51) Int. Cl. A62D 3/00

(52) U.S. Cl. 588/200

(57) ABSTRACT

A system and method for neutralizing hazardous materials in mail and the like, which includes a container having an enclosed chamber for containing mail, and an air stream in the chamber. There are air input and output ports for accepting a flow of air for distribution within the container and for directing the flow of air therefrom. There is a hazardous materials detection system for detecting the presence of one or more hazardous materials in the air flow, and a system for introducing into the chamber, a neutralizing agent that neutralizes, one or more targeted hazardous material. There is an arrangement for purging the neutralizing agent from the enclosed chamber.

### CROSS-REFERENCE TO RELATED APPLICATIONS

The present application claims the priority of previously filed provisional application Serial No. 60/344,848 filed Dec. 3, 2001 for Closed Loop System For Air Sampling Of Contained Mail Products, and utility application Ser. No. 10/201,169 filed Jul. 22, 2002, and previously filed application Ser. No. 10/277,069 filed Oct. 21, 2002 for System and Method For Detecting Hazardous Materials Inside Containers and the entire contents of all of these applications are incorporated herein by reference.

### FIELD OF THE INVENTION

The present invention relates to a system and method for detecting hazardous materials on or inside articles and then neutralizing them, and, more particularly, to a system and method for detecting hazardous materials, such as pathogens and chemical agents, inside mail, and then neutralizing them.

### BACKGROUND OF THE INVENTION

All economies depend upon the physical shipment of materials for their functioning including the shipment of mail, merchandise, raw materials, and other goods.

In some circumstances, it is desirable to subject the goods to some type of inspection to determine the presence of hazardous or impermissible materials, including biological and chemical materials. In general, sophisticated sensing systems are known for the detection of hazardous biological and chemical materials. For example, such systems can include conventional laboratory facilities as well as mobile or semi-mobile units that can automatically or semi-automatically detect the presence of the undesired substance or substances. One such vehicle-mobile system is the Joint Biological Point Detection System (JBPDS) developed for the United States military and designed to detect the presence of a number of biological pathogens. Others include sensor or detectors for hazardous chemicals, explosives, illicit drugs, radioactive particles, and other hazardous materials. These sensors can be used singly, or in combinations, to detect as many types of hazardous particles or vapors as required.

Currently when there is suspicious mail, it is all bulk irradiated as was done during the recent anthrax problem thereby delaying some mail for months and damaging or destroying some of the mail due to problems caused by the irradiation. For example some of this irradiated mail became brittle and pieces broke off.

U.S. Published Application No. US 2002/0126008 published Sep. 12, 2002 and filed Oct. 31, 2001 discloses use of sensors at various locations within a typical mail processing system to sense the presence of a harmful agent. This system is completely open to the ambient atmosphere.

U.S. Published Application No. US 2002/0124664 published September 12, 2002 and filed Feb. 1, 2002 discloses use of a mail sampling system used in a room separate from the remainder of a post office facility and in which there is an air intake fan and all outgoing air is filtered before release. Most often openings are formed in the parcels and mail for the sampling. The sampling system is said to determine whether mail is contaminated with a chemical or biological agent.

U.S. Pat. Nos. 5,942,699 and 6,324,927 disclose a manner of collective sampling of cargo items for contaminants such as chemical residues. The cargo items are placed into a special airtight chamber and physically agitated, such as by vibration, to release particulates and vapors from the items, and bursts of high pressure air is sent into the chamber. Heated air may also be used.

U.S. Pat. No. 3,915,339 discloses use of pressurized air into a container to loosen and cause free flow of material therein move.

U.S. Pat. No. 3,998,101 discloses a method and apparatus for sampling the atmosphere in non-hermetically-sealed containers by enclosing baggage in a chamber and varying the air pressure cyclically to mix a portion of the air in the baggage with the air in the chamber and a vapor detector is used to detect the presence of explosives or drugs in the baggage.

U.S. Pat. No. 4,580,440 discloses a method of detecting a contraband substance in freight cargo in which the container is agitated to disturb particulates therein and samples are taken of the air containing such particulates. The collected particulates are heated to drive off vapors indicative of the contraband substance and the vapors are analyzed in a mass analyzer.

U.S. Pat. No. 4,718,268 discloses a method and apparatus for detecting a contraband substance in freight cargo similar to that of U.S. Pat. No. 4,580,440 mentioned above.

U.S. Pat. No. 4,764,351 discloses a sterilization method and apparatus using a gaseous agent for sterilizing a gas for use in treating materials.

U.S. Pat. No. 5,322,603 discloses a method of an apparatus for treating infections medical wastes is which large sizes of medical waste in a sealed body are exposed to microwaves and heat.

U.S. Pat. No. 5,470,546 discloses apparatus for storing and sterilizing bio-hazardous waste in which air is evacuated and pressurized steam is injected.

U.S. Pat. No. 5,591,117 discloses a method and an apparatus for the disposal of material containing infective microorganisms such as bacteria, fungi and viruses by introducing the material into a container which can be charged with ozone and exposed to the action thereof until the microorganisms are killed, and then the ozone is discharged from the container and converted to a lower valence level and the container is then evacuated.

U.S. Pat. No. 5,700,426 discloses a method for decontaminating or sterilizing “in situ” a vacuum sealed container and device for implementing such method for sterilizing or decontaminating microorganisms or dangerous products.

U.S. Pat. No. 5,841,038 discloses a remote sampling device for possibly hazardous content of a container. A hollow needle punctures the container and is used to withdraw the contents or to introduce another substance. An inert gas can be introduced into the area where the needle punctures the container.

U.S. Pat. No. 5,859,362 discloses a trace vapor detection method and device of sampling a volume of air suspected of containing drug vapors, removing particulate matter and binding vapors of the drug for further analysis. The device has a sampling, filtration and vacuum port components.

U.S. Pat. No. 6,159,422 discloses methods and apparatus for the treatment of hazardous biological waste materials. A biological waste material is placed into a chamber and a vacuum applied. Water vapor is introduced into the chamber and electromagnetic radiation energy is applied to produce a plasma.

U.S. Pat. No. 6,183,950 discloses a method and apparatus for detecting viruses using primary and secondary biomarkers. There is a sampling section for sampling the atmosphere and includes an intake device for taking a sample. It includes a heater for distilling any cholesterol and/or fatty acids from the sample. There is an analysis section for determining whether cholesterol and/or fatty acids that are indicative of the likely presence of a virus in the sample are present.

U.S. Pat. No. 6,295,860 for explosive detection system and sample collecting device in which luggage enters the device and leaves the device after inspection in which a vapor leaking from the luggage is sampled by a sampling probe, negative corona discharge is used to ionize the vapor, and a mass spectrometer is used to detect the ionized vapor to determine whether or not an explosive is present.

Patent Abstracts of Japan Pub. No. 02159554 A published Dec. 12, 1988, Application No. 63313358 discloses a monitoring method of a pathogen or allergen in which a biosensor is provided near a suction port for air conditioning provided for each room of wall surface which tends to gather mold.

WO 91/09307 published Jun. 27, 1991, for Explosive Detection Screening System detects vapor or particulate emissions from explosives and other controlled substances and reports their presence and may also report the concentration. There is a sampling chamber for collection of vapors or other controlled substances and a concentration and analyzing system, and a control and data processing system for the control of the overall system. There are a number of U.S. patents in this series, including the following: U.S. Pat. Nos. 4,987,767; 5,109,691; 5,345,809; 5,465,607; and 5,585,575.

### SUMMARY OF THE INVENTION

The U.S. Postal Service has no way of determining if anthrax, or other bio-hazardous materials, or chemical agents are contaminating items of mail, and, if such contamination is present, neutralizing the mail in the same chamber where the contamination is sensed. It is desirable to do this before mail enters sorting and distribution centers.

As used herein, the term “neutralizing” refers to deactivating, degrading, rendering substantially harmless, decontaminating, and/or sterilizing any hazardous agent detected. For example, if a bio-hazard, such as anthrax, is detected, “neutralizing” means treating it so that it is not a substantial, or any, risk to people, such as by subjecting the anthrax to chlorine dioxide. In the event the hazard is of a chemical nature, “neutralizing” means treating the hazardous agent so that the chemical is not a substantial, or any, risk to people. This treatment may be a gas, or any other substance which will render the hazardous material substantially safe to people.

A convenient place to do the sensing of the hazardous material and then neutralizing it is in a chamber that is loaded with mail from local centers prior to distribution to main distribution centers. In one embodiment, a diffuser plate is mounted in the bottom of the chamber to ensure that air passing through it during a sampling stage will be distributed throughout the mail in the chamber and entrain particles on or in the mail or other articles.

In another embodiment, a perforated rotating drum is mounted inside the chamber which contains the mail or other articles and they are agitated so that pathogenic or harmful particles will be dislodged from them and carried out of the chamber in an air stream.

The air stream is then brought to a sensor or sensor suite for determining whether there are hazardous particles, such as anthrax or other pathogens, or other substance harmful to people, present.

After sensing, whether or not harmful particles are detected, in one embodiment, a partial vacuum can be applied to the chamber. The chamber, in the case of anthrax, is then filled with chlorine dioxide, ozone, or any of the other possible chemicals that will kill pathogens, but not harm mail or similar articles.

The use of a vacuum forces the gas or chemical to penetrate letters and packages. After sufficient residence time to kill or otherwise neutralize the pathogens, the gas or chemical is pumped out and the chamber is back-filled with air, several times. At this point, the mail may be withdrawn from the chamber for processing, or it may be analyzed again for pathogens by the same means described above. For organizations receiving relatively small batches of mail, a small chamber and a small capacity gas generator is sufficient.

In the above described processes, the detecting and neutralizing takes place within the same chamber, so that the complication of transporting the mail to another location is avoided. In addition, if for some reason the chamber cannot be completely sealed, the use of a sub-atmospheric pressure will provide for ambient air being brought into the chamber so that the hazardous contents do not escape into the ambient atmosphere. When a neutralizing gas is used, there would be flushing of the chamber with air to remove the gas. If desired, a sub-atmospheric pressure at this point will assist in the flushing. Sometimes several flushing steps may be required. The flushing may be able to be accomplished in a single step using the sub-atmospheric pressure during the flushing step, after which, the air would be exhausted through a scrubber into the ambient atmosphere.

The present invention provides a system and method for detecting hazardous materials inside containers and cargo carriers including semi-trailers, trucks, rail cars, intermodal shipping/cargo containers, and the like and then neutralizing such materials while in such containers.

In one type of system for sensing hazardous materials, air flow is established within the container to sweep hazardous particles that are entrained in the interior air and dislodge particles from surfaces therein and sweep the particles into a sensor unit for analysis.

A shipping or other type of container may be provided with at least one wall surface, preferably the floor surface, as an air, or other gas, distribution plenum with gas-flow holes or openings therein to allow the establishment of a gas flow path within the container. The gas flow follows a path upwardly from the floor-located distribution plenum upwardly through the cargo to entrain or otherwise carry or convey particulates, vapors, molecules, or atoms of material upwardly in the container to an exit port or opening. During the time that the gas flow pattern is established, a hazardous-materials detection sensor or sensor system is located at or otherwise introduced into the gas flow pattern, preferably at or downstream of the gas exit port, for a sufficient period of time to sample the flow for a plurality of undesired or hazardous materials, after which the neutralizing step is performed.

The air, or other gas, distribution plate or surface defines a gas distribution plenum there-beneath and includes a plurality of holes distributed across its surface. The gas flow pattern can be established by a gas-moving fan located within the container or by an auxiliary piece of equipment that connects to the container through a gas inlet port and a gas outlet port to establish a desired gas recirculation flow for some period of time. Once the flow has been established, a sensor or sensors are located within the exhaust flow for some period of time sufficient to effect the detection of any undesired or hazardous materials, after which the neutralizing step is performed.

The present invention advantageously provides a system and method for quickly and efficiently detecting and neutralizing hazardous materials inside containers typically used to ship materials, including mail, cargo, consumer goods, merchandise, and the like, while the shipped materials are contained and prior to the unloading of the container and possible dissemination/distribution of any hazardous materials.

Organizations receiving small batches of letters or packages need to be able to both sense harmful materials, like anthrax, in or on the mail and to neutralize such materials. Methods do not currently exist for simultaneously performing such functions in the same equipment.

The present invention combines these—a system for testing for hazardous materials and a system for neutralizing hazardous materials when they are present—in a way that allows both of these functions to be performed in the same chamber.

Other features and advantages will be apparent from the following detailed description of preferred embodiments taken in conjunction with the accompanying drawings.

### BRIEF DESCRIPTION OF THE DRAWINGS

FIG. 1 is a schematic diagram of the system of the present invention.

FIG. 2 is a flow diagram of the processing steps of the present invention.

FIG. 3 is a schematic end view of an exemplary container and an associated air flow moving system and hazardous-materials sensing system.

FIG. 4 is a schematic isometric view of an agitator in the form of a rotating cage.

FIG. 5 is a schematic isometric view of an agitator in the form of a vibrating foraminous sheet.

FIG. 6 is a schematic isometric view of an agitator in the form of a vibrating non-uniform sheet with holes in it.

### DESCRIPTION OF THE PREFERRED EMBODIMENTS OF THE INVENTION

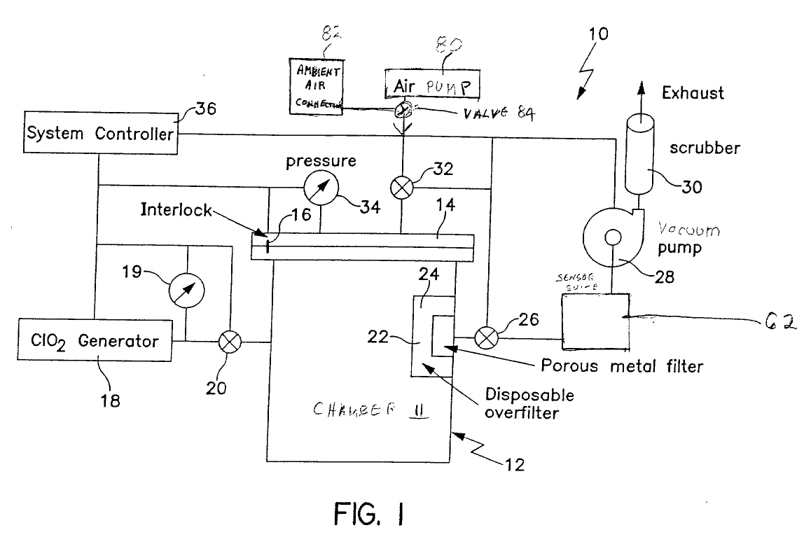

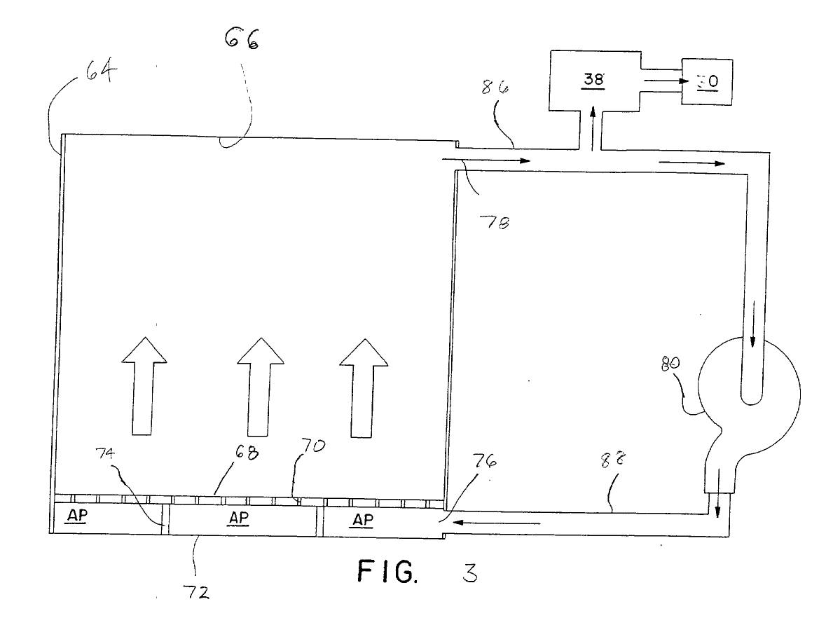

A system for entraining particulates in an air stream, sensing to determine whether the particulates are hazardous, and, in the event they are hazardous, neutralizing mail in accordance with the present invention is shown schematically in FIG. 1 and designated generally therein by the reference character 10. As shown, the system 10 includes sealable container 12 having a chamber designed to accept mail in a selected quantity, i.e., bulk mail. The container 12 includes a lid or cover 14 that can be opened and closed as desired; the cover 14, when closed, forms a gas-tight closure. An interlock 16 can be provided as part of the container 12 structure. Another embodiment of the container and chamber is shown and described in connection with FIG. 3.

As an alternative, an autoclave may be used which has a processing chamber. In this event, the mail may be placed into trays or tubs, a number of which are placed onto wheeled carts which are then wheeled into the container for processing.

Another alternative is to use a semi-trailer or other container, which may not be gas-tight. For such a situation, a sub-atmospheric pressure can be provided to reduce the possibility of hazardous agents escaping into the ambient air. However, care should be taken so that the sub-atmospheric pressure does not create stresses on the semi-trailer which exceed the trailer strength. Whether an autoclave, a semi-trailer, or other type of container is used, a chamber is provided in which both the sensing of hazardous materials and the neutralization of such hazardous materials is accomplished.

An air pump 80 is used to create an air flow through the mail in the container 12 to entrain particles in or on the mail which are then directed through valve 26 to a sensor suite 62 to test for hazardous materials, after which the air may be moved to a scrubber to cleans the air before its release. As an alternative embodiment, the air would be recirculated when hazardous material has not been sensed. In some cases, if hazardous material is sensed, it is saved for later testing and/or archiving.

A gas generator 18 having a pressure gauge 19 is provided to generate or otherwise supply a quantity of gas that neutralizes anticipated biohazards and this is used when hazardous material such as anthrax is detected. In the preferred embodiment, chlorine dioxide (ClO₂) is the preferred gas. The gas generator 18 is connected to the container 12 via a controllable valve 20. The gas generator also controls the water vapor content of the active gas. However, depending upon the circumstances, neutralizing agents, known in the art, other than gas may be used.

The container 12 is selectively exhausted to the atmosphere via first filter 22 and a second filter 24 through a selectively controlled valve 26. The valve 26 is connected to a scavenge vacuum pump 28 and to a scrubber 30 that removes the chlorine dioxide gas prior to being exhausted to the ambient air.

Additionally, a selectively controllable valve 32 can be controlled to admit ambient air into the container 12, and a pressure gauge 34 is provided to indicate pressure in the container 12.

A system controller 36, in the form, for example, of a programmed microprocessor, computer, or functionally equivalent device, is connected to the various components to implement the method.

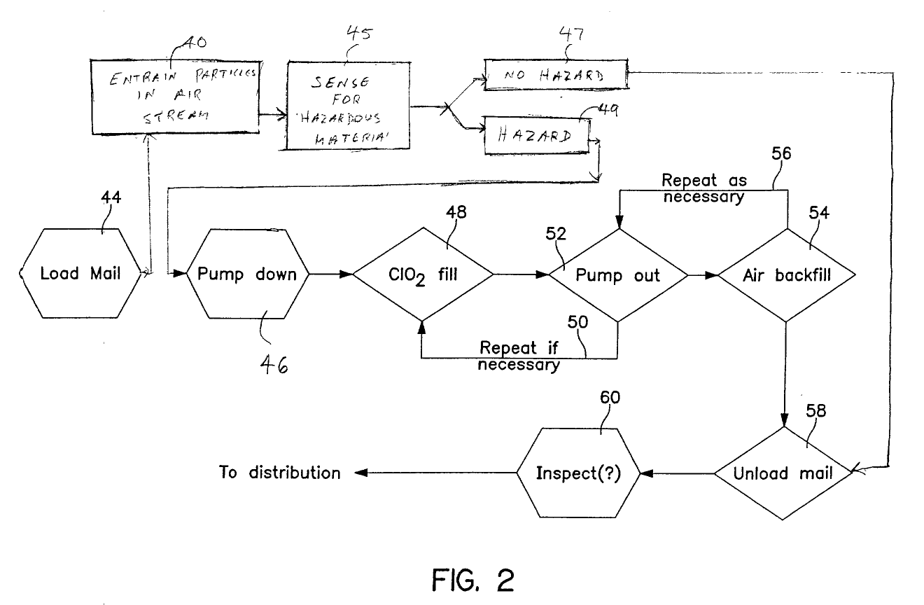

The method of the present invention is shown in the flow diagram of FIG. 2 and is representative of techniques for testing the mail for hazardous material and then, if such material is present, exposing the mail to the active gas.

After the mail is loaded into container 12 in step 44, Load Mail, and after the container 12 is sealed closed, valve 26 is opened and an air stream is provided to entrain particles which are in or on the mail into the air stream in step 40. Then, there is sensing of the air for hazardous material in step 45. In the event no hazardous material is detected in step 47, the mail is then unloaded in step 58 and, if desired, inspected in step 60 and then distributed.

However, in the event there is hazardous material detected in step 49, then the vacuum pump 28 is operated to provide step 46, Pump Down, the container 12 to a sub-atmospheric pressure. In general, a pressure of about 0.5 atm is sufficient.

After the container 12 is pumped down, the valve 26 is closed and the valve 20 is opened to admit the chlorine dioxide into the container 12 to provide step 48, ClO₂ Fill. In general, the pressure of the chlorine dioxide can be somewhat below atmospheric pressure, at atmospheric pressure, or above atmospheric pressure. Since the chamber 11 was initially at a lower pressure, the chlorine dioxide will flow into, or otherwise diffuse into, the interior of each piece of mail and into interstices in the interior of the mail. The gas will enter, for example, by diffusion through the envelope walls or through less-than fully sealed seams, flaps and the like. In general, a concentration of about 4% or less chlorine dioxide is adequate.

The mail is exposed to the gas for a selected period of time empirically determined to neutralize the target bio-hazardous material. If it is determined that the bio-hazardous material has not completely neutralized the hazardous material to the extent desired, step 50, Repeat As Necessary, is performed and a further treatment with the gas is performed. This can be accomplished in different manners depending upon the circumstances. For example, if the material is not neutralized, the mail can remain in the gas for a longer period of time. If desired, a gas flow can be provided, such as by a pump or fan to circulate the gas throughout the chamber 11 including through the mail containers until the bio-hazardous material has been neutralized. In some cases, it may be prudent to go to step 52, Pump Out, first and then go to steps 50 and 48 in which the chamber will be refilled with fresh active gas.

Thereafter, the valve is 26 is opened to allow the vacuum pump 28 to scavenge the gas from the chamber 11 while the valve 32 is opened thereafter to allow ambient air to enter the chamber 11 and effectively purge the chamber 11.

As shown, the process of steps 52, Pump Out, and 54, Air Backfill, can be repeated in step 56, Repeat As Necessary, fill can be repeated as necessary. Sensors for chlorine dioxide, chlorine, or for other active gases and their degradation products, can be attached to the chamber 12 to determine whether or not the chamber has been purged sufficiently to e safely opened. When the gas has been purged to the necessary extent, step 58, Unload Mail, is performed, and, if desired, step 60, Inspection, can be done and the mail then continues to distribution.

The present invention advantageously provides a method for neutralizing mail that efficiently exposes both the exterior and the interior of the mail pieces, and the interstices therein, to a gas or other neutralizing agent, known in the art, that neutralizes, targeted biohazards or other types of hazardous materials.

A system and method for detecting hazardous materials inside containers in accordance with the present invention may be embodied in a container 64 having a chamber 66 which can be sealed, or, in part, in shipping containers and cargo boxes typically used to ship letter-mail and packages, manufactured goods, raw materials, and the like,

As shown in FIG. 3, a representative container 64 is shown having a chamber 66. The container 64 may be provided with a foraminous wall 68, which can be a side wall or a bottom wall that defines part of an air distribution system. The wall 68 can be in the form of a distribution plate provided with a series of openings or holes 70 that function to distribute a flow of air. For example, the openings can take the form of regularly or irregularly spaced circular holes 70.

The distribution plate 68 is spaced above the floor 72 of the container and may be held in place by appropriately spaced beams 74 or joists to define an air distribution plenum AP. In one type of container, e.g., when it is a very large container, there can be a spacing of about 15 or so centimeters (i.e., about 6 inches) above the floor 72 of the container 64 is believed sufficient. The container 64 is also provided with an air-input port 76 which allows admission of an air flow, as described below, into the air plenum AP as well as an air output port 78 located at or adjacent the upper portion of the container. The support beams 74 of the air plenum AP, as well as other ducting or baffles (not specifically shown) can function to divide and distribute the input air throughout the air plenum AP so that the input air will be sufficiently and uniformly distributed in the air plenum AP to create a reasonably uniform generally upwardly moving air flow within the container 64.

As shown in FIG. 3, the air output port 78 is located at or near the top of the semi-trailer 10 and is designed to function as a collection point for some or all of the upwardly directed air flow. The air output port 78 is preferably circular and located intermediate the ends of the container 12. If desired, the air output port 78 can be located in the top of the container 12 or at one or the other of the ends thereof. Additionally, it is contemplated that more than one air output port can be used as part of the disclosed system.

As shown in FIGS. 1 and 3, the container 64 is designed to inter-engage with an air recirculation and sensor system. The air recirculation and sensor system may includes an air mover 80 having an inlet duct 86 that is selectively connectable to the air outlet port 78 and an outlet duct 88 that is selectively connectable to the air inlet port 76 of the container 64. The air mover 80 can take the form, for example, of a single or multi-stage radial flow or axial flow fan having sufficient air moving capability to recirculate the available volume of air within the container 64. A sensor suite 38 (typically including a plurality of diverse sensors) is connected to the air inlet duct 86 and is designed to accept at least a portion of the recirculating flow for analysis and thereafter pass the analyzed flow through a filter, adsorber, or scrubber 30.

The sensors could include the Joint Biological Point Detection System (JBPDS) manufactured by Intellitec of Jacksonville, Fla., designed to detect and identify a plurality of biological pathogens. The sensors may include other similar types of fully-integrated, detecting and identifying biological agent sensors, utilizing automated immunoassay methods, that include the 4WARN manufactured by General Dynamics Canada of Calgary, AB, Canada; Portal Shield or JBREWS manufactured by Sentel of Alexandria, Va.; or others. Some sensors could also take the form of a PCR-Nucleic Analysis system such as those manufactured by Cepheid of Sunnyvale, Calif., or Idaho Technologies of Salt Lake City Utah. Some sensors could also take the form of detectors that serve only to detect the presence of biological material in particles in the analyzed air stream, like the BIONI, manufactured by Pacific Scientific Instruments of Grant's Pass, Oreg.; the Biological Aerosol Warning System Tier III developed by MIT Lincoln Laboratories in MA; the UV-APS, manufactured by TSI Inc. of St. Paul, Minn.; the UV-FLAPS and BARTS manufactured by General Dynamics Canada of Calgary, AB, Canada; or others. The sensors could also include a particle detector-based system like the Biological Aerosol Warning System Tier I, manufactured by Lockheed Martin of Manassas, Va.

In addition, a simple collector, such as a filter or a BioCapture system manufactured by Mesosystems, Inc of Kennewick, Wash.; or other type of particle capture device could also be part of the sensor suite. Such a unit would be intended to capture particles for later laboratory analyses, including culturing, immunoassay, and PCR-nucleic acid methods. Such a unit would also be useful for forensic purposes and for the collection of evidence. The sensor suite could also include one or more chemical warfare agent sensors such as ion mobility spectrometers including the ChemPro 100 or the M-90 manufactured by Environics Oy of Mikkeli, Finland, or similar sensors manufactured by Graseby Ionicics and ETG; surface acoustic wave sensor-based devices including the JCAD sensor, manufactured by BAE Systems of San Antonio, Tex.; the HAZMATCAD, manufactured by Microsensor Systems Inc. of Bowling Green, Ky.; the Micro Chem Lab on a Chip manufactured by Sandia National Laboratories in Albuquerque, N. Mex.; the SnifferSTAR sensor manufactured by Lockheed Martin of Manassas, Va. and Sandia National Laboratories; or others. They could also take the form of explosives sensors, such as those manufactured by Ion Track Instruments of MA or Smith's Sensors of NJ (formerly Barringer), or contraband drugs sensors manufactured by the latter two manufacturers. The sensors could also include sensors for radiological particles in air, including Geiger counters and other radiological detectors. A plurality of detectors will generally be used.

It is envisioned that one use of the disclosed embodiments is in the detection of biological pathogens, such as anthrax spores, in the mail system. In one embodiment, mail trucks, including both mail carrying semi-trucks and other mail trucks having a separate and defined cargo container, will move mail in the usual manner. Prior to unloading of the vehicle, the air inlet duct 86 and the air outlet duct 88 of the air recirculation and sensor system are connected to the semi-trailer. The air mover 80 is operated to establish a recirculation flow from the distribution plate 68 upwardly through the interior air space of the containment. In general, the air flow circulation is maintained until sufficient time has elapsed, usually a period of minutes, to cause any air entrainable particles, including bacteria, bacterial spores, viruses, rickettsia, toxins, low volatility chemical particles including chemical warfare agent particles like VX, explosives particles, particles of illicit drugs, radioactive particles, and others, as well as vapors including chemical warfare agents, explosives and explosives related compounds, illicit drugs, hazardous industrial chemicals, and others, to enter and diffuse into some of the available interior air and the air flow. After a suitable period of time, the sensor system 38 is then operated to sample the air flow to determine the presence or absence of hazardous or otherwise undesirable matter in the contained cargo, after which, in the event a hazardous material is detected, the neutralizing step is performed.

The distribution plate 68 is shown mounted above the load-carrying floor 72 of the container 64. As can be appreciated, other configurations are contemplated. For example, the distribution plate 68 and the associated air plenum AP can be mounted as part of the ceiling of the cargo containment to establish a top down air flow, in one side wall or the other to define a side to side air flow, and/or in an end wall of the containment to define an air flow that moves from one end to the other end of the container.

The present invention advantageously provides a system and method for detecting hazardous materials inside containers used to ship or convey mail, manufactured goods, raw materials, and the like with a minimum of costs and time, after which neutralization is performed.

The present invention is particularly usable to detect and identify harmful particulate or vapor materials, including anthrax, in a container, full of U.S. mail. The diffuser plate 68 is placed on the floor of the container. The diffuser plate may be of steel running the full length and width of the container, with holes in it, which may, for example, be ½ inch holes. The plate can be supported about 6″ above the floor, when the floor is a truck trailer, although particular arrangements may require a greater or lesser space. This plate becomes a permanent part of the container. The mail is then loaded in on top of this plate and the container transported to a sorting and distribution center.

In one embodiment, a vehicle may be driven up to the container 64 to analyze it for anthrax or other contaminants including other biological warfare agents, chemical warfare agents, radiological materials, explosives vapors or particles, and the like. This vehicle would have the air blower, or other air moving means, attached to it. The outlet of this blower connects to a fitting in the side or bottom of the container that leads the pressurized air under the diffuser plate. The inlet to this blower attaches to the headspace above the mail. The purpose of the blower is to pass air through the mail in a recirculating fashion, sweeping any biological particles, including anthrax, and any chemical warfare agent gases, radiological particle, etc., into the blower's inlet. In the event a hazardous material is detected, the neutralization is performed in the same chamber so that it is performed without the necessity to transport the mail to another chamber for neutralization.

If the air stream is fast enough the mail may be agitated in the way that gas flows and diffuser plates are used to agitate particles in a fluidized catalyst bed. The inlet or outlet to the pump may also have a biological warfare agent sensor (which is especially useful to solve the current anthrax problem in connection with the U.S. Postal Service) and, if desired possibly some other sensors including chemical warfare agent, radiological, explosives, and the like, attached to it. This JBPDS (or other) sensor detects biological particles in a few seconds and, if they are present, it collects a 5 minute air sample (this is just an example of the time, and the particular arrangement may require a greater or lesser amount of time), and then use its specific identifier to determine whether or not anthrax or some other specific agent were present. If other detectors are included, they simultaneously analyze for the other materials listed above. When a hazardous material is detected, the neutralizing step is performed. This should solve the postal service problem of letting anthrax contaminated mail into mail sorting and distribution centers.

Also, some gentle agitation may be provided in the mobile type of containers (trucks and rail cars, e.g.) as the vehicle moves toward its destination, caused by the natural movement up and down and side to side that occurs with such vehicles.

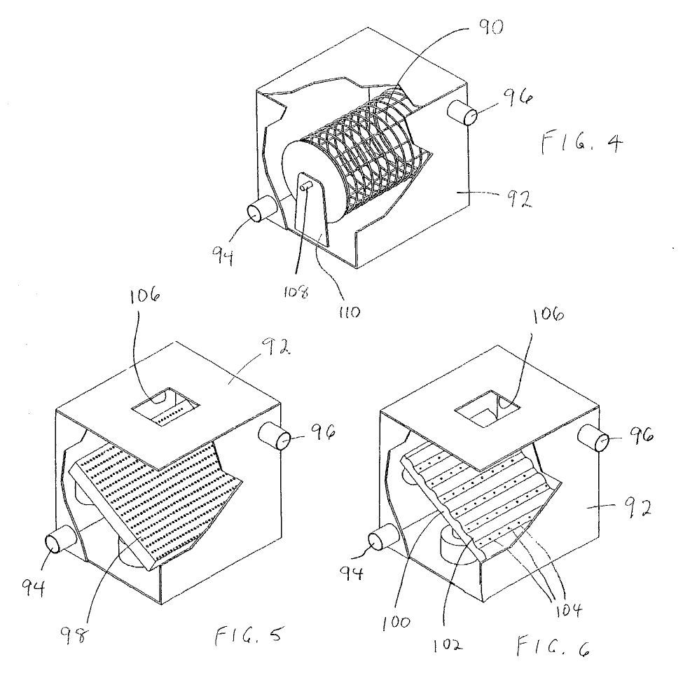

FIG. 4 shows a rotating cage 90 in a container 92 having an air inlet 94 and an air outlet 96. Mail is placed into the cage 90 and the cage is rotated as an air stream moves through the container 92 to entrain hazardous particulate located on or in the mail. The cage is mounted for rotation on an axle 108 which may be attached to a motor, and supports 110 hold the axle and allow it to rotate.

FIG. 5 shows the container 92 with an opening 106 in the top for viewing and/or for loading and unloading the mail. There is an air inlet 94 and air outlet 96 and a vibrating screen 98 or foraminous sheet to provide the agitation to loosen the particulate so it will become entrained in the air flow.

FIG. 6 shows a plate 100 with an uneven surface 102 with holes 104. the plate 100 is vibrated to loosen the particulate so that it can become entrained in the air stream.

It should be noted that in order to prevent contaminated air from entering the ambient atmosphere, the container may be sealed and the air connections to the container and the air blower and other connections also sealed to prevent the air from escaping into the ambient atmosphere before testing for hazardous materials has been completed.

Also, if the container cannot be completely sealed, or for other reasons, instead of using an air blower, a vacuum generator may be connected so that the container will have a slight under pressure when compared to the ambient atmosphere (a level of under pressure consistent with the structural stability of the container) and therefore will not force air from inside the container to the ambient atmosphere, but, rather will bring some ambient air into the container in the event it is not completely air tight. Some, but not all, of the sensors discussed above would function properly when placed on the line that connects the container with the vacuum generator.

Thus, as described the present invention is a method (and the apparatus) for entraining particles of hazardous material, testing the same, and the use of chlorine dioxide (ClO₂) or another substance to to neutralize hazardous agents which are on or inside of mail. The method can be applied using virtually any other type gas or chemical or other agent that neutralizes biological warfare agents, including ethylene oxide, other chlorine containing species and others. However, the present disclosure describes the use of ClO₂ as one preferred embodiment because it has been shown to be effective against biological agents, such as anthrax spores. However other neutralizing agents are known in the art and can be used against biological and non-biological hazardous materials.

In the present invention, mail, (either as individual pieces or as items in trays, held in baskets or bins, which are in turn placed onto wheeled racks, or transported by automated means or fork lifts, or any other method of holding and transporting batches of mail in such a way that each piece is in contact with air), is wheeled into a vacuum chamber.

This can be an autoclave, such as those that are used for processing composite structures like aircraft and satellite components, and the like, or hyperbaric chambers, or other vacuum chambers, and a vacuum is created sufficient to remove air from around and inside the letters or packages. A “hard” vacuum is not required in such an application. A vacuum of ½ atmosphere (pressure 389 torr) or even 9/10 atmosphere (700 torr) would be suitable for this application. The chamber is then backfilled with a ClO₂/air mixture generated by a commercial ClO₂ generator such as that made by CDG Technology, or generators made by CDG's competitors. Controlling the humidity of the active gas is important. Because a partial vacuum exists inside the chamber, and also inside the letters and parcels in the chamber, gas will surround and fill the letters when the chamber is filled with the ClO₂/air mixture. It has been shown that 100 ppm of ClO₂ in air, held for 4 hours, will kill every single spore held on a test strip that contains 1,000,000 Bacillus subtilis var. Niger spores (also known as Bacillus Globigii or simply “BG”). BG is a spore widely used as a simulant for the nearly identical Bacillus anthracis spores that are responsible for anthrax disease. Higher concentrations of ClO₂ in air, which could be 1,000 ppm or even a little higher, will act faster to reduce the concentration of remaining viable spores to zero, or to a very small number that will be insufficient to cause cases of either inhalation anthrax (requiring 8,000 to 50,000 spores to be breathed in for infection to occur) or cutaneous anthrax in most cases. For such spores, proper control of humidity helps the gas permeate the spore coat and degrade or deactivate the spores, rendering them harmless.

After this treatment of the mail is complete, the chamber is again evacuated to the previous level and is refilled with air. This process may need to be repeated at least 3 times, or more as needed, to remove residual ClO₂ gases that might otherwise remain in the letters or packages. Exhaust ClO₂/air mixtures, or air contaminated with small amounts of ClO₂ are passed through a simple water scrubber made of polyvinyl chloride plastic (PVC) or other materials to remove all ClO₂ before it is exhausted into the air. The scrubber liquid can usually be safely discharged into a sewer system, since no biohazards or ClO₂ will remain. An environmental health and safety specialist would usually be consulted, however, on applicable regulations relating to the discharge and handling of this scrubber solution.

After the multiple evacuation/air refill cycles are finished, residual ClO₂ levels will be low. They can be detected in real time inside the chamber once it has been refilled with air. Sensors for ClO₂, or sensors for Cl, will detect the presence of residual chemical to quite low levels. Commercially available electrochemical, solid state (metal oxide sensors) and spectroscopic sensors can be used. After this evacuation/refill process is finished, the mail is removed from the chamber and processing continues.

The ClO₂ concentration vs. neutralization time relationship can be calibrated for different sized mail pieces, and for bundled bulk mail, so that each can be treated in an optimal method, or so that a single method applicable to the “worst case” condition, can be used. This process is a batch process taking place before mail enters a main mail processing and distribution center, a company's mail room, and the like. For high volumes of mail, multiple chambers may be required, although they could be served by the same pumping system and the same ClO₂ generator. Mail normally waits for quite some time to enter the processing and distribution center, so that little or no additional time is added to the overall mail processing and distribution sequence. This system can also be used by small company mail rooms that will treat just one or two batches of mail per day and will thus only need one chamber.

Any small residual chlorine, the breakdown product of ClO₂, or residual ClO₂ itself, will be at such low levels that they will not be harmful to people. They will be detectable to mail recipients as a “swimming pool”-like odor. This will likely dissipate during the time that elapses between mail decontamination and receipt of the mail by the public.

ClO₂/air mixtures are simply made from chlorine gas (Cl) brought in cylinders, and sodium chlorite (NaClO₂), a material that can be contained in 55 gallon drums, and a humidified air stream. They can be made in various concentrations of ClO₂ in air, but are best held below about 1% ClO₂ in air, as the explosive limit for this gas is in the 4-10% range. For this reason, ClO₂ is never shipped, but is always produced where and when it is required. Thus, the nature of the generation equipment and the ClO₂ generation process make it impossible to exceed the explosive limit, so an explosion hazard will not exist. The same type of standard, commercial ClO₂ generators and technology used for various commercial and hospital biological purification applications, will be used to make the ClO₂/air decontaminant mixture for mail and parcel purification.

It is to be noted that while anthrax (and other bio-hazardous materials) have been used in the above example, the invention is applicable to any type of hazardous material or agents. Also, while chlorine (or other gas) has been used in the above example, the invention is applicable to any type of neutralizing agent. Various neutralizing agents are known in the art which may be used in connection with the present invention.

As will be apparent to those skilled in the art, various changes and modifications may be made to the illustrated method for decontaminating and/or sanitizing mail of the present invention without departing from the spirit and scope of the invention as determined in the appended claims and their legal equivalent.

1. A system for neutralizing hazardous materials in mail and the like, comprising:
a. a container having an enclosed chamber for containing mail;
b. means for providing an air stream in said chamber;
c. air input and output ports for accepting a flow of air for distribution within the container and for directing the flow of air therefrom;
d. a hazardous materials detection system for detecting the presence of one or more hazardous materials in the air flow;
e. means for filling the chamber with a neutralizing agent that neutralizes, one or more targeted hazardous material; and
g. means for purging the neutralizing agent from the enclosed chamber.

2. A system as defined in claim 1, wherein said chamber, ports and detection system are sealed so that air may not escape therefrom into the ambient atmosphere.

3. A system as defined in claim 1, wherein said hazardous materials detection system includes sensors for sensing one or more of biological pathogens including bacteria, bacterial spores, viruses, rickettsia, toxins, low-volatility chemical particles including chemical warfare agents, VX particles, explosives particles, particles of, or particles associated with, illicit drugs, and other biological particles and materials, and radioactive particles, chemical vapors including chemical warfare agents, explosives and explosives-related compounds, illicit drugs, hazardous industrial materials, other chemical vapors and materials, and other hazardous materials.

4. A system as defined in claim 1 further comprising means for agitating mail in the chamber to loosen particles and/or vapors therefrom so that they can be entrained in the air stream.

5. A system as defined in claim 4 wherein said agitating means includes said means for providing an air stream and which provides an air flow to move the air at a sufficient velocity to agitate the mail.

6. A system as defined in claim 4 wherein said container is a semi-trailer, a rail car or a mail container.

7. A system as defined in claim 1 further comprising an air flow generator.

8. A system as defined in claim 7 wherein said air flow generator creates an under-pressure at the air outlet.

9. A system as defined in claim 7 wherein said air flow generator creates an over-pressure at the air inlet.

10. A system for detecting and decontaminating hazardous materials comprising:
a cargo container for containing a cargo;
air distribution means for distributing an air flow within the container;
air input and output ports for accepting a flow of air for distribution within the container and for directing the flow of air thereform;
a hazardous materials detection system for detecting the presence of one or more hazardous materials in the air flow;
means for filling the container with an agent for neutralizing one or more targeted hazardous materials; and
means for purging the neutralizing agent from the container.

11. The system of claim 10, wherein said materials detection system includes sensors for sensing one or more of biological pathogens including backeria, bacterial spores, viruses, rickettsia, toxins, low-volatility chemical particles including chemical warfare agents, VX particles, explosives particles, particles of, or particles associated with, illicit drugs, and other biological particles and materials, and radioactive particles, chemical vapors including chemical warfare agents, explosives and explosives-related compounds, illicit drugs, hazardous industrial materials, other chemical vapors and materials, and other hazardous materials.

12. A system as defined in claim 10, further comprising a system controller for controlling the means for filling and means for purging the neutralizing agent from the container.

13. A system as defined in claim 12, wherein said container is sufficiently large to contain a large plurality of mail bins.

14. A method for detecting and neutralizing hazardous materials in mail, comprising the steps of:
a. placing mail into an airtight container having at least one air inlet and at least one air outlet;
b. moving air through the container and through the mail contained therein between said air inlet and said air outlet;
c. sensing the air for at least one hazardous material with a sensor;
d. directing air leaving the container to said sensor;
e. filling the chamber with a neutralizing agent that neutralizes targeted hazardous materials; and
f. purging the neutralizing agent from the container.

15. A method as defined in claim 14 wherein steps e. and f. are repeated as needed.

16. A method as defined in claim 14, further comprising the step of:
providing an alert signal when the air being analyzed contains at least trace amounts of hazardous material.

17. A method as defined in claim 14, further comprising the step of:
agitating the mail in the container sufficiently to dislodge at least a trace amount of any hazardous material contained therein or thereon.

18. A method as defined in claim 14 wherein the step of moving air creates an under-pressure at the air outlet.

19. A method as defined in claim 14 wherein the step of moving air creates an over-pressure at the air inlet.

20. A method as defined in claim 14 wherein the hazardous material is anthrax spores and the neutralizing agent is ClO₂.

21. A method as defined in claim 20 wherein the humidity is controlled.

22. A method of detecting and neutralizing mail containing hazardous material comprising the steps of:
a. loading mail into a confined chamber;
b. using an air stream in the chamber to entrain particulates in or on the mail;
c. sensing for hazardous materials;
d. in the event hazardous materials are sensed, partially evacuating the atmosphere in the chamber;
e. filling the chamber with an active gas that neutralizes one or more targeted bio-hazardous materials;
f. maintaining the mail and gas in the chamber for a sufficient period of time to neutralize the bio-hazardous material;
g. pumping the gas out of the chamber and allowing air to enter to reduce the active gas to a safe level;
h. examining the chamber to determine whether the bio-hazardous material has been neutralized;
i. if the bio-hazardous material has not been neutralized, repeating steps e. through i.;
j. in the event the bio-hazardous material has been neutralized, examining the chamber to determine whether the active gas has been reduced to a safe level;
k. in the event, the active gas is not at a safe level, repeating steps g. through k.; and
l. in the event the active gas is at a safe level, unloading the mail from the chamber.

23. A method as defined in claim 22, wherein steps b. through k. are carried out under the control of a computer.
